(19) United States
(12) Patent Application Publication
(10) Pub. No.: US 2006/0103961 A1
(43) Pub. Date: May 18, 2006

(54) Digital recording and reproducing apparatus, recording medium used therefor, and error factor estimating method and error factor estimating system thereof

(75) Inventors: Shinichi Sugawara, Kanagawa (JP); Masayuki Usui, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/260,262

(22) Filed: Oct. 28, 2005

(30) Foreign Application Priority Data
Oct. 28, 2004 (JP) 2004-314109

(51) Int. Cl. G11B 27/36

(52) U.S. Cl. 360/31

(57) ABSTRACT

An error factor estimating method estimates a factor of an error occurring when information recorded on a digital recording medium is reproduced by a digital recording and reproducing apparatus. The error factor estimating method includes the steps of: recording error factor estimation data on a digital recording medium; reproducing the error factor estimation data from the digital recording medium to obtain an error factor estimation signal; and estimating the factor of the error based on the factor estimation. The error factor estimating method can estimate the factor of occurrence of the error based on a factor estimation signal obtained by reproducing the error factor estimation data from the recording medium by the digital recording and reproducing device without affecting user data recorded on the recording medium at all.

The entire contents of literatures cited in this specification are incorporated herein by reference.

### BACKGROUND OF THE INVENTION

The present invention relates to a digital recording and reproducing apparatus, a recording medium used therefor, and a method and a system for estimating an error factor thereof.

A digital recording and reproducing apparatus such as a magnetic disk or magnetic tape recording and reproducing apparatus is used as an external storage device of a computer or the like. A state of each of the digital recording and reproducing apparatus and a recording medium used therefor is generally evaluated by an error rate corresponding to the number of erroneous data. The error rate varies depending on a recording medium, a recording and reproducing head, a recording and reproducing circuit, a signal processing method and the like. The causes of variations in error rate are, for example, the deterioration of a recording medium itself, a scratch on a surface of the recording medium, the adhesion of dust on the surface of the recording medium or the recording and reproducing head, an increased amount of variation in space (gap) between the recording medium and the recording and reproducing head, a jitter exceeding an allowable level and the like. Therefore, the monitoring of the error rate can provide, for example, a rough indication of the end of a lifetime of the recording medium.

The error rate increases exponentially. Thus, once the error rate starts increasing, there is a possibility that information recorded on a recording medium cannot be read even at a relatively early stage. JP 60-111379 A discloses an apparatus of finding an appropriate time for replacing a magnetic recording medium such as a floppy® disk by obtaining a lifetime consumed by the use of the magnetic recording medium, for example, by summing up the number of revolutions of the floppy® disk. Specifically, the end of the lifetime of the magnetic recording medium is detected based on the number of revolutions of the disk or elapsed time, thereby improving the safety of the magnetic recording medium.

Moreover, in JP 8-163498 A, when a head scans a recording medium at a predetermined high reproduction speed, an area for recording special reproduction data and error correction check codes is provided on a scanning track of the head. At the same time, any one of an error correction check code added to the special reproduction data and an error correction check code added at least to data output from record data generating means is recorded in the area for recording the error correction check code. In the recorded signal, an identification signal of the error correction check code recorded in the recording area of the error correction check code is added and recorded. As a result, a digital video signal and a digital audio signal are input in the form of a bit stream. In a digital VTR for recording and reproducing the bit stream, the error correction capability of the error correction check code during normal reproduction or high-speed reproduction is improved.

Although a change in error rate can be detected in a conventional recording and reproducing apparatus, there is a problem in that the factor of a change in error rate cannot be quickly specified. Specifically, as described above, since the error rate varies depending on the recording medium, the recording and reproducing head, the recording and reproducing circuit, the signal processing method and the like, various kinds of analysis are required to specify the factor of occurrence of an error. Therefore, a long time is disadvantageously needed to specify the factor of occurrence of an error. Therefore, when the error rate changes, it is conventionally difficult to quickly find the factor of the change in error rate to cope with it.

### SUMMARY OF THE INVENTION

The present invention is devised to solve the above problem and has an object to provide an error factor estimating method, an error factor estimating system, a digital recording and reproducing apparatus and a recording medium used therefor, which allow quick and easy estimation of a factor of an error caused by recording and reproducing data on and from a recording medium with a digital recording and reproducing apparatus.

In order to achieve the above object, a first aspect of the present invention provides an error factor estimating method for estimating a factor of an error occurring when information recorded on a digital recording medium is reproduced by a digital recording and reproducing apparatus, the error factor estimating method including the steps of: recording error factor estimation data on the digital recording medium; reproducing the error factor estimation data from the digital recording medium to obtain an error factor estimation signal; and estimating the factor of the error based on the error factor estimation signal.

In the error factor estimating method according to the present invention, it is preferable that the error factor estimation data contain a data string providing a solitary inverted waveform during reproduction. It is also preferable that the error factor estimation data contain a data string repeated in a cycle selected from the group consisting of 2T, 4T and 8T where T is a recording channel clock cycle.

It is preferable that the error factor estimating method according to the present invention further include steps of: measuring an error rate from the medium and comparing the error rate with the error factor estimation signal. It is also preferable that the error factor estimating method further include the steps of comparing the factor estimation signal with a preset threshold value to display a position of occurrence of the error based on the result of comparison on a display device. Moreover, it is also preferable that the error factor estimating method further include the steps of: comparing the error factor estimation signal with a preset threshold value; and determining whether or not the information is recorded based on the result of comparison in the step of comparing.

It is preferable that the preset threshold value be preset for at least one selected from the group consisting of a maximum amplitude value of the error factor estimation signal, a full width at half-maximum corresponding to a half amplitude of the maximum amplitude value, a jitter of the error factor estimation signal and asymmetry of the error factor estimation signal.

It is also preferable that the error factor estimating method further include recording the error factor estimation signal as a history for each use.

A second aspect of the present invention provides an error factor estimating system for estimating a factor of an error, including: a recording medium recorded error factor estimation data for estimating a factor of a error thereon; a recording and reproducing device for recording information on the recording medium and reproducing the information therefrom; and an inspection device for inspecting a state of at least one of the recording medium and the recording and reproducing device connected there to the inspection device based on an error factor estimation signal obtained by reproducing the error factor estimation data with the recording and reproducing device.

In the error factor estimating system according to the present invention, it is preferable the inspection device include: a measuring section for measuring at least one of a maximum amplitude value of the error factor estimation signal, a full width at half-maximum corresponding to a half amplitude of the maximum amplitude value, a jitter of the error factor estimation signal and asymmetry of the error factor estimation signal; a collecting section for collecting measurement values measured by the measuring section; and a first storage portion for storing the measurement value.

It is preferable that the inspection device includes a display section connected to the collecting section to display the measurement value. It is also preferable that the collecting section measure an error rate and compare the error rate with the measurement value stored in the first storage section and the display section display a result of comparison.

Moreover, it is preferable that the inspection device further include: a second storage section in which a threshold value for the measured value of the error factor estimation signal is preset; the collecting section compares the error factor estimation signal and the threshold value with each other to estimate a position of occurrence of the error based on the result of comparison; and the display section displays the estimated position of occurrence of the error.

Furthermore, it is preferable that the inspection device control the recording or the reproduction of the recording and reproducing device based on the result of comparison.

It is also preferable that the recording medium be housed within a cartridge having a recording section for recording the error factor estimation signal detected for each use as history information; and the recording and reproducing device include a history information recording and reproducing section for recording history information in the recording section of the cartridge and reproducing the recorded history information.

A third aspect of the present invention provides a digital recording and reproducing apparatus comprising: a recording and reproducing section for recording information on a recording medium and reproducing the recorded information therefrom, the recording medium recorded error factor estimation data for estimating a factor of an error thereon; a recording and reproduction control section for controlling a recording and reproducing operation of the recording and reproducing section; a memory for storing a threshold value for a error factor estimation signal obtained by reproducing the error factor estimation data in the recording and reproducing section; and an arithmetic processing unit for comparing the error factor estimation signal with the threshold value to generate a control signal for controlling the recording and reproducing operation of the recording and reproducing section based on the result of comparison to output the control signal to the recording and reproduction control section.

It is preferable that the control signal be for controlling start and stop of the recording of the information on the recording medium. It is also preferable that the recording and reproducing section record the error factor estimation signal on the recording medium as the history information for each use.

Moreover, it is preferable that the recording medium be housed within a cartridge having a recording section for recording the history information; and the recording section include a history information recording section for recording the history information on the recording section. It is also preferable that the storage section be an RFID.

A fourth aspect of the present invention provides a recording medium for recording information thereon and reproducing the information therefrom by using a digital recording and reproducing device, the recording medium comprising: error factor estimation data for estimating a factor of an error occurring when the information is recorded and reproduced by using the digital recording and reproducing device.

In the recording medium according to the present invention, it is preferable that the error factor estimation data contain a data string providing a solitary inverted waveform during reproduction. It is also preferable that the error factor estimation data contain a data string repeated in a cycle selected from the group composing of 2T, 4T and 8T where T is a recording channel clock cycle.

In the error factor estimating method and the error factor estimating system according to the present invention, a factor estimation data is recorded on the recording medium to estimate a factor of occurrence of the error occurring when user data is recorded on or reproduced from the recording medium by the digital recording and reproducing device. The error factor estimating method and the error factor estimating system can estimate the factor of occurrence of the error of the recording medium and/or the digital recording and reproducing device based on a factor estimation signal obtained by reproducing the error factor estimation data from the recording medium by the digital recording and reproducing apparatus without affecting user data recorded on the recording medium at all. Moreover, since a change in error rate can be predicted before the error rate actually changes, the operation of the digital recording and reproducing apparatus can be controlled based on the prediction. As a result, a write error or the like can be avoided to stably record and reproduce information.

Since the digital recording and reproducing apparatus according to the present invention can compare the factor estimation signal obtained by reproducing the factor estimation data in the recording and reproducing section with the threshold value to control the recording and reproducing operation of the recording and reproducing section based on the result of comparison, a change in error rate can be predicted before the error rate actually changes by setting the threshold value based on the change in error rate. Therefore, since the operation of the digital recording and reproducing apparatus can be controlled based on the prediction, a write error or the like can be avoided to stably record and reproduce information.

Furthermore, since the factor estimation data for estimating the factor of the error which occurs when the information is recorded and reproduced by using the digital recording and reproducing apparatus is recorded on the recording medium according to the present invention, the factor of the error can be easily estimated by using the recording medium for the error factor estimating method and the error factor estimating system described above. Thus, the recording medium is the most suitable as a recording medium for the error factor estimating method and the error factor estimating system according to the present invention.

### BRIEF DESCRIPTION OF THE DRAWINGS

In the accompanying drawings:

FIG. 1 is a block diagram showing a schematic configuration of an error factor estimating system according to the present invention;

FIG. 2 is a schematic configuration view of a digital recording and reproducing apparatus of the error factor estimating system shown in FIG. 1;

FIG. 3 is a view schematically showing a state where an EFED recording area is formed in each of data blocks of a magnetic tape;

FIG. 4 is a view schematically showing a state where the EFED recording area is formed in every two blocks of the magnetic tape;

FIG. 5 is a view schematically showing a state where the EFED recording area is formed in each of the data blocks at BOT, the middle position, and EOT of the magnetic tape;

FIG. 6 is a view for illustrating a state where different error factor estimation data are recorded in the respective EFED recording area formed in the data blocks of the magnetic tape;

FIG. 7 is a block diagram showing an error factor estimating system different from that shown in FIG. 1 according to the present invention;

FIG. 8 is a schematic configuration view of a magnetic tape recording and reproducing apparatus according to the present invention;

FIG. 9 is a block diagram showing a variation of the error factor estimating system shown in FIG. 7; and

FIG. 10 shows an example of history information used in the error factor estimating system according to the present invention.

### DESCRIPTION OF THE PREFERRED EMBODIMENTS

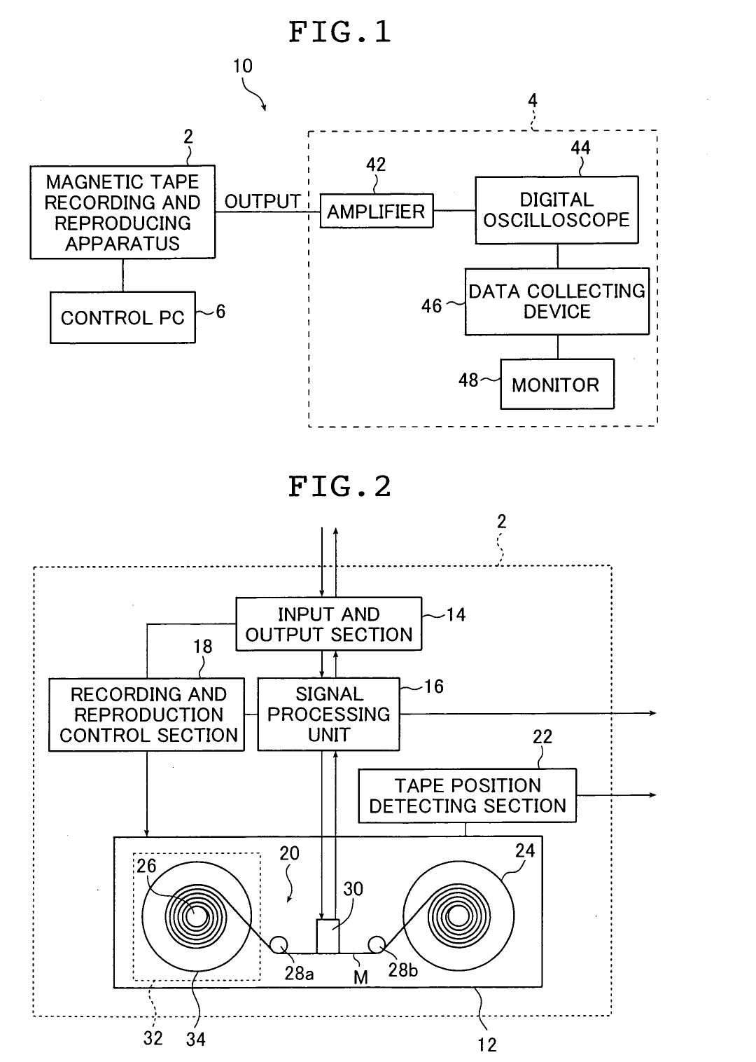

Hereinafter, an error factor estimating method, an error factor estimating system, and a digital recording and reproducing apparatus and a recording medium according to the present invention will be described in detail based on the preferred embodiments illustrated in the accompanying drawings. FIG. 1 is a block diagram of an error factor estimating system 10 according to the present invention. The error factor estimating system 10 basically includes: a magnetic tape recording and reproducing apparatus 2 corresponding to a digital recording and reproducing apparatus; an inspection apparatus 4; and a control PC (personal computer) 6.

The inspection apparatus 4 constituting the error factor estimating system 10 includes: an amplifier 42; a digital oscilloscope 44; a data collecting device 46; and a monitor 48. The inspection apparatus 4 is capable of inspecting a state of the magnetic tape recording and reproducing apparatus 2, a recording medium (a magnetic tape) used for the apparatus and their interfaces.

The control PC 6 can control the recording on and the reproduction from the magnetic tape by the magnetic tape recording and reproducing apparatus 2. The control PC 6 can output data to the magnetic tape recording and reproducing apparatus 2 to record the data in a predetermined area of the magnetic tape. Moreover, the control PC 6 can control the magnetic tape recording and reproducing apparatus 2 to reproduce the data recorded on the magnetic tape to obtain the reproduced data from the magnetic tape recording and reproducing apparatus 2. Although a personal computer is used as the control PC in this embodiment, a work station (WC) may also be used.

The magnetic tape recording and reproducing apparatus 2 serves to record information on the magnetic tape and to reproduce the recorded information therefrom. FIG. 2 shows a schematic configuration of the magnetic tape recording and reproducing apparatus 2. The magnetic tape recording and reproducing apparatus 2 basically includes: a drive 12; an input and output section 14; a signal processing unit 16; a recording and reproduction control section 18; and a tape position detecting section 22.

The drive 12 includes a magnetic tape drive mechanism 20 and a magnetic head 30. The magnetic tape drive mechanism 20 includes: a take-up reel 24; a spindle 26 engaged with the center of a hub 34 of a magnetic tape cartridge 32; guide rollers 28a and 28b; and a drive unit (not shown) for rotatably driving the take-up reel 24 and the spindle 26. The magnetic tape drive mechanism 20 can relatively move the magnetic tape M with respect to the magnetic head 30 while sliding the magnetic tape M against the magnetic head 30.

The magnetic head 30 is provided between the guide rollers 28a and 28b. The magnetic head 30 can record a signal on the magnetic tape M and reproduce the signal recorded on the magnetic tape M. As the magnetic head 30, various types of head such as a fixed head or a rotary head can be used. The magnetic head 30 is composed of a recording head and a reproducing head. As the recording head, for example, an MR head or a GMR head can be used.

The signal processing unit 16 can process a data signal input from the control PC 6 (see FIG. 1) through the input and output section 14 to record the data signal on the magnetic tape M. The signal processing unit 16 can also process an output signal reproduced by the magnetic head 30 to output the signal to the input and output section 14. Moreover, the signal processing unit 16 can identify a signal (a factor estimation signal) from various signals recorded on the magnetic tape M based on error factor estimation data described below to selectively extract and output it.

The recording and reproduction control section 18 can control the drive 12 based on the control signal input from the control PC 6 through the input and output section 14 to control a recording and reproducing operation such as the running and the rewind of the magnetic tape M by the magnetic tape drive mechanism 20, the recording of a signal on the magnetic tape M and the reproduction of the signal recorded on the magnetic tape M by the magnetic head 30.

The tape position detecting section 22 is connected to the drive 12 to detect the position of the magnetic tape when the magnetic head 30 slides on the magnetic tape Mo record or reproduce the data. The tape position detecting section 22 can output the detected position as tape position information.

The magnetic tape M, on and from which data is recorded and reproduced by using the magnetic tape recording and reproducing apparatus 2, will now be described. The magnetic tape M is provided with-an area for recording the error factor estimation data. The error factor estimation data is used for checking the quality of a signal and can be read out by the magnetic head 30 when the magnetic tape recording and reproducing apparatus 2 is driven. Then, the readout signal is analyzed by the inspection apparatus 4 (see FIG. 1) to estimate the factor of occurrence of the error, for example, the adhesion of dust to the magnetic head or the surface of the recording medium, a scratch on the surface of the recording medium, the deterioration of the recording medium or a spacing. Such error factor estimation data may be recorded in advance on the magnetic tape M as a recording format or may be recorded on the magnetic tape M in an initializing operation.

The error factor estimation data is preferably data which does not cause any waveform interference during reproduction, that is, data that provides a solitary inverted waveform during reproduction (hereinafter, referred to as solitary inverted data). As the error factor estimation data, 2T, 4T and 8T data may be used. A combination of the data can also be used as the error factor estimation data. Herein, T is a recording channel clock cycle, and 1T corresponds to a minimum magnetic reversal width.

An example of the error factor estimation data is described below.
2T: 1010101010
4T: 11001100110011001100

8T: 11110000111100001111000011110000
The solitary inverted data:
11111111111111000000000000000111111111111111000000000000000

In addition to the above-described error factor estimation data, a data row formed by the combination thereof:
1010101010110011001100110011001111000011110000111100001111000011 111111111111000000000000000111111111111111000000000000000 can also be used.

Besides those described above, for example, signal data in a cycle between 2T and 3T or signal data in an arbitrary cycle such as 16T can be used. In accordance with an error to be estimated, data in an arbitrary cycle can be used. As described above, when data in accordance with an error to be estimated is used, the error can be easily and quickly estimated from a readout signal of the data.

Moreover, as the error factor estimation data, a clock of a data signal generally recorded on the magnetic tape can also be used. Specifically, a date string, which is recorded on the magnetic tape to generate a clock, may be used as the error factor estimation data.

The data length of the error factor estimation data is not limited to the data length described above. An arbitrary data length can be used as long as the signal quality can be checked. If the data length is too long, there is a possibility that the number of data signals that can be recorded on the recording medium may decrease to reduce a recording capacity. Therefore, the data length is preferably 100 bits or less.

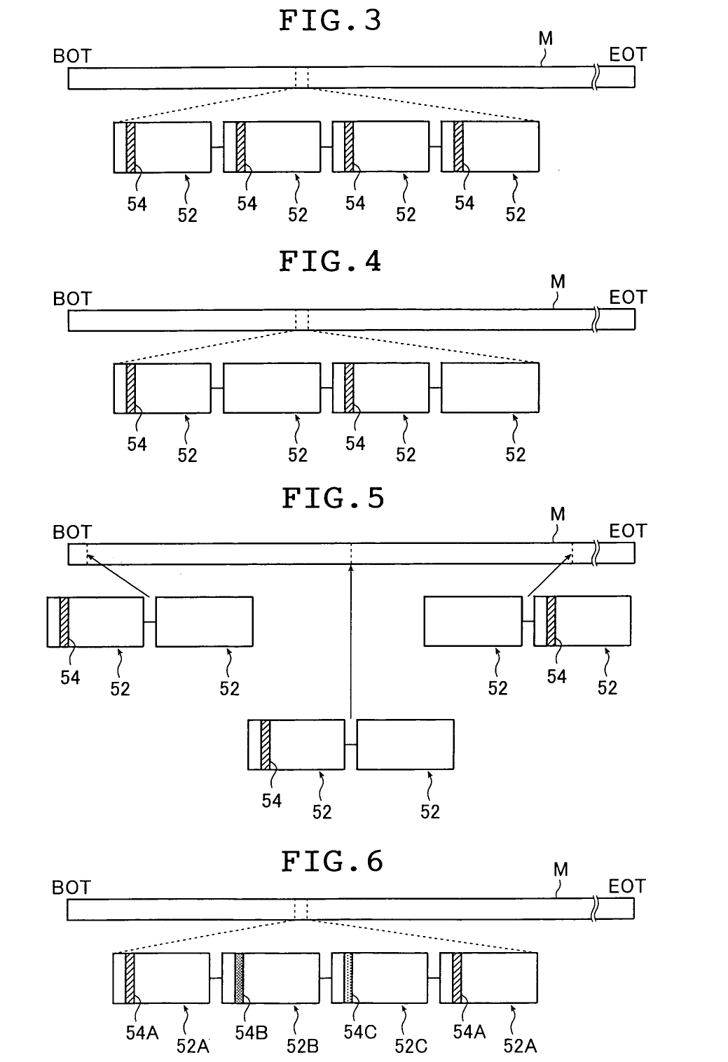

In the present invention, the error factor estimation data can be recorded at an arbitrary position of the magnetic tape M, and is preferably recorded at a given position of a data block of the magnetic tape M. FIG. 3 schematically shows a state where an area for recording error factor estimation data (hereinafter, referred to as a EFED recording area) 54 is formed in each data block 52 of the magnetic tape M. The error factor estimation data is recorded in the EFED recording area 54 formed at a given position of the data block 52 as described above. As a result, when the error factor estimation data is to be read, it is only necessary to perform control so that an access is made to the given position (the EFED recording area) of the data block 52. Therefore, the size of a circuit for extracting the error factor estimation data can be reduced.

Moreover, the error factor estimation data is not required to be recorded in all the data blocks. For example, as shown in FIG. 4, the EFED recording area 54 may be formed in every two data blocks 52 so that the data is recorded in the thus formed EFED recording area 54. Alternatively, the error factor estimation data may be recorded at given intervals, i.e., every several meters on the magnetic tape. Further alternatively, as shown in FIG. 5, the error factor estimation data may be recorded in the EFED recording area 54 formed in the data block 52 at BOT (Begin Of Tape) of the magnetic tape M, in the error EFED recording area 54 formed in the data block 52 at the middle of the magnetic tape M and the EFED recording area 54 of the data block 52 at EOP (End Of Tape) of the magnetic tape M, respectively. Further alternatively, the error factor estimation data may be recorded in the data blocks in an intermittent manner, for example, in every N data blocks (N is a positive integer) or in each odd-numbered or even-numbered data block.

Several kinds of quality management data may be individually recorded in each of the data blocks in a given order. For example, as shown in FIG. 6, the solitary inverted data, the 2T signal and the 8T signal can be recorded as different error factor estimation data in EFED recording areas 54A to 54C of the respective data blocks 52A to 52C of the magnetic tape M.

Moreover, the 2T and the 8T signals may be recorded in the even-numbered data blocks, whereas the solitary inverted waveforms may be recorded in the odd-numbered data blocks.

The error factor estimation data as described above is read out by the magnetic tape recording and reproducing apparatus. From the readout signal waveform, at least one of a peak level (a maximum amplitude value), a Pw50 value (a full width at half-maximum corresponding to a half amplitude of the maximum amplitude value), asymmetry, a jitter and a dropout is detected. Based on the detected value, for example, the factor of various errors such as the spacing, the adhesion of dust and the scratch is estimated. Therefore, the error factor estimation data can be formed in various patterns in accordance with the factor of an error to be estimated. For example, when an error caused by a lowered output due to the spacing between the recording and reproducing head and the magnetic tape is to be estimated, the error factor estimation data can be composed as 101010101100110011001111100001111000011110000. When an error caused by a phase shift is to be estimated, the error factor estimation data can be composed as, for example, 1111111111111000000000000001111111111111000000000000001111111111 111100000000000000.

The inspection apparatus 4 shown in FIG. 1 will now be described in detail. The inspection apparatus 4 is connected to the magnetic tape recording and reproducing apparatus 2 as described above. The inspection apparatus 4 basically includes, as shown in FIG. 1: the amplifier 42; the digital oscilloscope 44; the data collecting device 46; and the display device (monitor) 48. The amplifier 42 is connected to the magnetic tape recording and reproducing device 2 shown in FIG. 2 and can amplify a signal (hereinafter, referred to as a factor estimation signal) obtained by reading the error factor estimation data with the magnetic head to output the amplified signal to the digital oscilloscope 44. The digital oscilloscope 44 can output the peak level of a signal waveform, the Pw50, the asymmetry and the jitter and the like of the factor estimation signal.

The data-collecting device 46 can obtain the tape position information from the tape position detecting section 22 of the magnetic tape recording and reproducing apparatus 2. The data-collecting device 46 can store the peak level, the Pw50, the asymmetry and the jitter and the like of the factor estimation signal output from the digital oscilloscope 44 in a storage section not shown in the drawing in association with the tape position information. The data-collecting device 46 as described above can be configured by using, for example, a personal computer. In this case, a hard disk provided in the personal computer can be used as the storage section. The tape position information and the factor estimation signal described above can be stored on the hard disk in association with each other.

Moreover, the data-collecting device 46 can calculate a trend from the factor estimation signal stored in the storage section in a computing unit not shown in the drawing to compare the trend with the error rate to generate graph display data. The data-collecting device 46 can also generate data for displaying the peak level, the Pw50, the jitter and the asymmetry and the like of the factor estimation signal together with the error rate as a table.

The monitor 48 is connected to the data-collecting device 46. The monitor 48 is a display device for displaying a graph showing the comparison between the trend of the factor estimation signal created in the data collecting device 46 and the error rate or for displaying the measured values of the factor estimation signal, that is, the peak level, the Pw50, the jitter, the asymmetry and the like with the error rate as a table. The comparison between the factor estimation signal and the error rate in the above-described manner allows easy and quick estimation of the factor of the error based on the graph and the table displayed on the monitor 48 of the inspection apparatus 4 when the error rate increases during the recording and reproducing operation of the magnetic tape.

A threshold value may also be set in advance based on the error rate for the factor estimation signal to be measured. In this manner, when the measured factor estimation signal exceeds the threshold value, the measured values, the position on the magnetic tape at which the error factor estimation data of the factor estimation signal is recorded, and the like are displayed on the monitor 48.

Alternatively, the position, at which the magnetic tape is supposed to deteriorate, may be specified based on the factor estimation signal to be displayed on the monitor 48.

According to the error factor estimating system 10 shown in FIG. 1, if once the error factor estimation data recorded on the magnetic tape is read out to detect the factor estimation signal, the factor of an increase in error rate during the recording and reproduction of the magnetic tape can be quickly estimated. Therefore, the subsequent operation for removing the factor can be quickly performed. Moreover, if data for estimating the factor of an error of the magnetic tape, for example, the factor of deterioration in the quality of a material or the characteristics of the magnetic tape is used as the error factor estimation data, the magnetic tape can be easily evaluated. Accordingly, the error factor estimating system 10 can also be used as an evaluation apparatus of a recording medium. Moreover, since the error factor is estimated based on the factor estimation error, the error factor can be specified without erasing user data recorded on the magnetic tape.

Furthermore, if data for checking the quality at the shipment of the magnetic tape is used as the error factor estimation data in the error factor estimating system described above, the quality conformance of a fabricated magnetic tape with the quality defined by standards or the like can be easily inspected. Specifically, the error factor estimating system can be used as a magnetic tape inspection apparatus.

Although the digital recording and reproducing apparatus is configured as the magnetic tape recording and reproducing apparatus in this embodiment, the present invention is not limited thereto. The present invention can also be applied to any apparatus as long as it is a digital recording and reproducing apparatus capable of recording a digital signal on a recording medium and reproducing a signal recorded on the magnetic medium. For example, the digital recording and reproducing apparatus can be configured as a recording and reproducing apparatus of an optical recording disk such as a magnetic disk, a magneto-optical disk or a DVD. Moreover, by adding the error factor estimation data to transmitted data and estimating the factor of the error based on received data obtained by receiving the error factor estimation data, the present invention can be also applied to a data communication system.

Moreover, although the error factor estimation data is recorded on the recording medium, the error factor estimation data may also be recorded in a recording and reproducing apparatus for recording and reproducing data to and from the magnetic medium. In this case, the error factor estimation data recorded in the recording and reproducing apparatus is read out. Based on the readout signal, the factor of an error in the recording and reproducing apparatus can be estimated.

Moreover, in above embodiment, the factor estimation signal obtained by reproducing the error factor estimation data is extracted in the signal processing unit 16 of the magnetic tape recording and reproducing apparatus 2 to be output to the inspection apparatus 4. However, all the output signals from the magnetic head of the magnetic tape recording and reproducing apparatus may be output to the inspection apparatus 4 so that the factor estimation signal is extracted from the output signals in the inspection apparatus 4. In this case, a signal-processing unit for extracting the factor estimation signal from the output signals is suitably provided in the inspection apparatus 4.

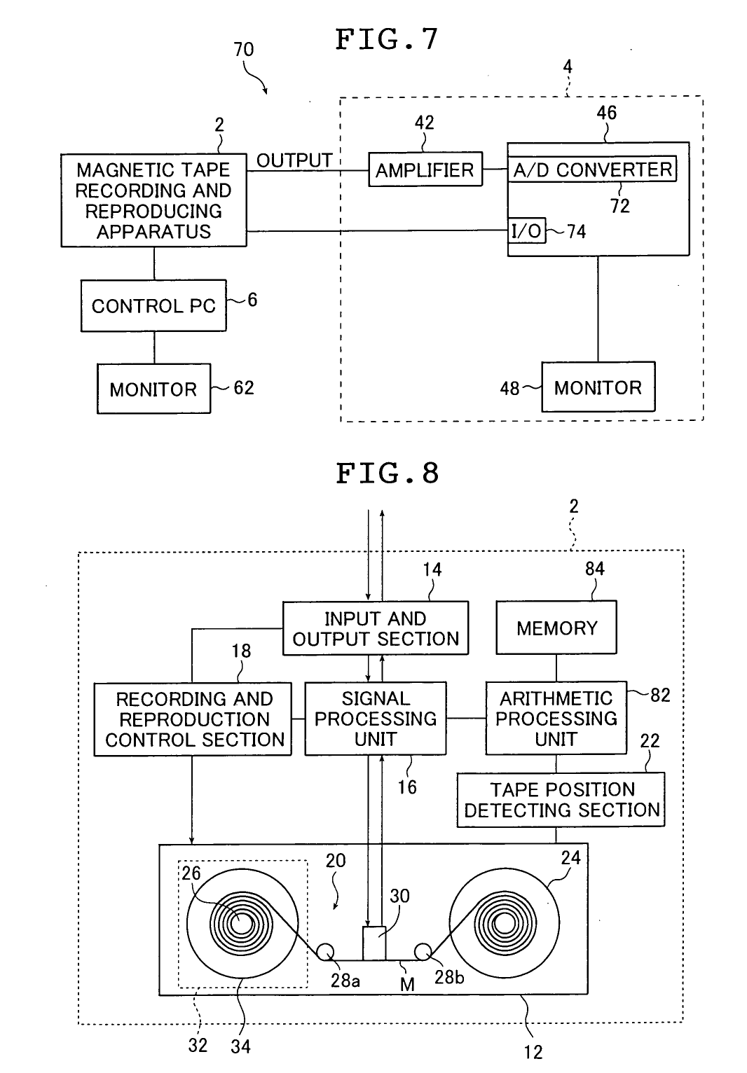

Next, another configuration example of the error factor estimating system according to the present invention will be described with reference to FIG. 7. An error factor estimating system 70 shown in FIG. 7 basically includes: the magnetic tape recording and reproducing apparatus 2; the inspection apparatus 4; the control PC 6; and a monitor 62. The inspection apparatus 4 includes: the amplifier 42; the data collecting device 46; and the monitor 48 corresponding to a display device. Since the magnetic tape recording and reproducing apparatus 2, the control PC 6, and the amplifier 42 and the monitor 48 constituting the inspection apparatus 4 are the same as those of the error factor estimating system 10 shown in FIG. 1, the description thereof is herein omitted.

In FIG. 7, the data-collecting device 46 constituting the inspection apparatus 4 includes an A/D converter 72 and an input and output section 74. The A/D converter 72 is connected to the amplifier 42. An analog signal amplified by the amplifier 42 is digitally converted. The measured values of the converted signal are stored in a predetermined storage area of the data-collecting device 46. Specifically, after the factor estimation signal based on the error factor estimation data, which is detected by the magnetic head 30, is amplified by the amplifier 42, the signal is converted into a digital signal by the A/D converter 72. Then, the measured values of the factor estimation signal converted into the digital signal such as the peak level, the Pw50, the asymmetry and the jitter are measured to be stored in the predetermined storage area.

The input and output section 74 provided in the data collecting device 46 is connected to the tape position detecting section 22 of the magnetic tape recording and reproducing apparatus 2. With this structure, the tape position information can be obtained from the tape position detecting section 22. The above-described measured values of the factor estimation signal such as the peak level, the Pw50, the asymmetry and the jitter can be recorded in the recording area in association with the tape position information obtained by the input and output section 72. The data-collecting device 46 as described above can be configured with, for example, a personal computer.

The error factor estimating system 70 having the structure shown in FIG. 7 can quickly estimate the factor of an increase in the error rate during the recording and reproduction of the magnetic tape simply by detecting the factor estimation signal based on the error factor estimation data recorded on the magnetic tape. Accordingly, the subsequent operation for avoiding or removing the factor can be quickly performed.

The case where the error factor estimating system 70 shown in FIG. 7 is used to determine whether or not to start data recording on the magnetic tape to control the recording and reproducing operation of the magnetic tape recording and reproducing apparatus 2 based on the result of determination will be described. As described above, the measured values of the factor estimation signal obtained by reproducing the error factor estimation data recorded on the magnetic tape by the magnetic head of the magnetic tape recording and reproducing apparatus 2 are collected by the data collecting device 46. A threshold value is set for each of the measured values of the error factor estimation data. The threshold value may be preset or may be appropriately set while the user is observing the monitor 48. The threshold values are stored in a predetermined storage area of the data collecting device 46.

The threshold values as described above can be set, for example, based on the result of comparison between the error rate and the factor estimation signal. For example, the threshold values can be appropriately set after the trend indicating the peak level, the amount of jitter, the asymmetry, the value of the Pw50 and the number of dropouts and how they change is checked in advance from the factor estimation signal detected when the error rate reaches a predetermined value (for example, in the range of 10⁻⁶ to 10⁻⁴). Moreover, when plural pieces of error factor estimation data are used, the threshold values can be set for each of the error factor estimation data. For example, when 2T, 4T and 8T are used as the error factor estimation data, the threshold values of the peak level, the asymmetry and the jitter can be set for each signal obtained by reproducing each data.

The data-collecting device 46 compares each of the measured values of the factor estimation signal output from the magnetic tape recording and reproducing apparatus 2 and the threshold value with each other. When there is no factor estimation signal exceeding the threshold values, the data collecting device 46 outputs a recording start signal, which instructs the start of recording of data in the data block, to the control PC 6. The magnetic tape recording and reproducing apparatus 2 receiving the recording start signal records the user data in a predetermined data block of the recording tape. On the other hand, if any of the factor estimation signals exceeds the threshold value, the data collecting device 46 outputs a recording stop signal, which instructs the magnetic tape recording and reproducing apparatus 2 not to start the recording of data in the data block, to the control PC 6. The recording operation of the magnetic tape recording and reproducing apparatus 2 is restrained by the recording stop signal.

By determining the start or the stop of the recording based on the comparison between the factor estimation signal and the threshold value as described above, data writing in a predetermined area of the magnetic tape or on the magnetic tape itself before the error rate increases to make data writing or reading of the written data impossible. Therefore, a write error can be avoided in advance to perform stable recording and reproduction.

In this case, when the factor estimation signal exceeds the threshold value, the data collecting device 46 outputs the recording stop signal to the control PC 6 to stop the recording operation of the magnetic tape recording and reproducing apparatus 2. The magnetic tape recording and reproducing apparatus 2 can also be controlled to perform a different operation in accordance with various factor estimation signals. For example, in the case where data for checking an error due to the adhesion of dust is used as the error factor estimation data, when a signal obtained by reading out the data with the magnetic head exceeds the threshold value, the magnetic tape recording and reproducing apparatus may be operated to display a massage recommending the cleaning of the magnetic head with a cleaning tape. If the magnetic tape recording and reproducing apparatus 2 includes a cleaning device, the magnetic tape recording and reproducing apparatus 2 may be controlled to implement a cleaning operation.

In the case where data for checking a lifetime of the recording medium is used as the error factor estimation data, there is a higher possibility that the error rate increases if the recording operation is further continued when a signal obtained by reading the data with a magnetic head exceeds the threshold value. Therefore, for example, the magnetic tape recording and reproducing apparatus 2 may be operated to display a warning indicating that the recording medium will come to the end of its lifetime or a danger warning sign indicating that a further recording operation is dangerous, to issue a message to eject a magnetic tape cartridge, or to forcibly eject the magnetic tape cartridge.

In the error factor estimating system 70 shown in FIG. 7, the inspection apparatus 4 extracts the measured values of the factor estimation signal detected by reproducing the factor estimation signal to compare the measured values of the factor estimation signal with the predetermined threshold values. Based on the result of comparison, the operation of the magnetic tape recording and reproducing apparatus is controlled. Alternatively, the function of the inspection apparatus 4 as described above may be incorporated into the magnetic tape recording and reproducing apparatus 2 so that various operations are implemented. FIG. 8 schematically shows a block diagram of the magnetic tape recording and reproducing apparatus having the function as described above.

The magnetic tape recording and reproducing apparatus 2 includes, as shown in FIG. 8: the drive 12; the input and output section 14; the signal processing unit 16; the recording and reproduction control section 18; the tape position detecting section 22; an arithmetic processing unit 82; and a memory 84. Since the drive 12, the input and output section 14, the signal processing unit 16, and the recording and reproduction control section 18 are the same as those shown in FIG. 2, the description thereof is herein omitted.

The arithmetic processing unit 82 is connected to the signal processing unit 16, the tape position detecting section 22 and the memory 84. The arithmetic processing unit 82 can obtain the factor estimation signal from the signal processing unit 16 to obtain the peak level, the PW50, the asymmetry, the jitter and the like from the factor estimation signal. The measured values are output to the memory 84 to be stored therein. The arithmetic processing unit 82 can obtain tape position information for indicates tape position detected the factor estimation signal is detected, from the tape position detecting section 22 to store the measured values of the factor estimation signal in association with the tape position information in the memory 84.

The above-described threshold values are recorded in the memory 84. The threshold values may be input from an input device not shown in the drawing to be stored in the memory or may be input from the control PC for controlling the magnetic tape recording and reproducing apparatus and then recorded in the memory 84 through the input and output section 14, the signal processing unit 16 and the arithmetic processing unit 82. Alternatively, the control PC and the memory 84 may be directly connected to each other so that the threshold values are input from the control PC to the memory 84. Further alternatively, the input and output section 14 and the memory 84 may be connected to each other so that the threshold values are input from the input and output section 14 to the memory 84.

The arithmetic processing unit 82 compares the measured values of the factor estimation signal with the threshold values to output the control signal to the signal processing unit 16 in accordance with the result of comparison. The signal processing unit 16 outputs the control signal to the recording and reproduction control section 18. The recording and reproduction control section 18 controls the recording and reproducing operation of the drive 12 serving as a recording and reproducing section based on the control signal. In this embodiment, the control signal is output to the recording and reproduction control section 18 through the signal processing unit 16. However, the arithmetic processing unit 82 may be directly connected to the recording and reproduction control section 18 so that the control signal is directly output from the arithmetic processing unit 82 to the recording and reproduction control section 18.

Moreover, the magnetic tape recording and reproducing apparatus 2 shown in FIG. 8 is configured to control the recording operation of the drive 12. However, a display section for displaying a warning sign may be provided for the magnetic tape recording and reproducing apparatus 2 to display a warning sign when the factor estimation signals exceed the threshold values as a result of comparison between the factor estimation signals and the threshold values. Moreover, when the factor estimation signals exceed the threshold values as a result of comparison between the factor estimation signals and the threshold values, the position of the magnetic tape, from which the factor estimation signal is detected, may be displayed as the error factor estimation position on a display section not shown or the like.

Next, the case where the error factor estimating system 70 shown in FIG. 7 is used to record the factor estimation signal, which is obtained by reproducing the error factor estimation data recorded on the magnetic tape each time the magnetic tape is used, on the magnetic tape as history information will be described.

In this embodiment, the magnetic tape has an area for recording the history information. Hereinafter, the area is referred to as a history information recording area. By the magnetic head of the magnetic tape recording and reproducing apparatus 2, the history information is recorded in the history information recording area. As the history information, for example, the date and time of use, a cartridge number (a serial number) housing the magnetic tape, a device number of the magnetic tape recording and reproducing apparatus, the measured values of the error factor estimation data, the error rate and the number of dropouts can be used. In the system shown in FIG. 7, the history information as described above is obtained by the control PC 6.

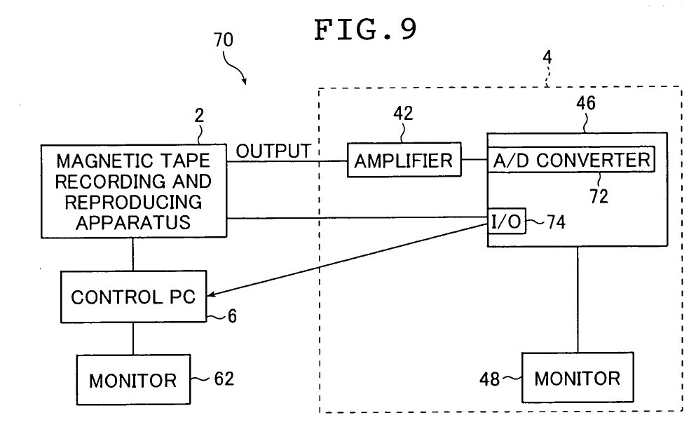

When the measured values of the error factor estimation data are used as the history information, the control PC 6 is connected to the data collecting device 46 to obtain the measured values of the factor estimation signal from the storage section (not shown) provided in the data collecting device 46 through the input and output section 74, as shown in FIG. 9. When a large number of the error factor estimation data are recorded, the measured values of the signals of all the error factor estimation data may be recorded as the history information. Alternatively, a representative measured value, for example, at least one of a maximum value, a minimum value and an average value may be recorded as the history information.

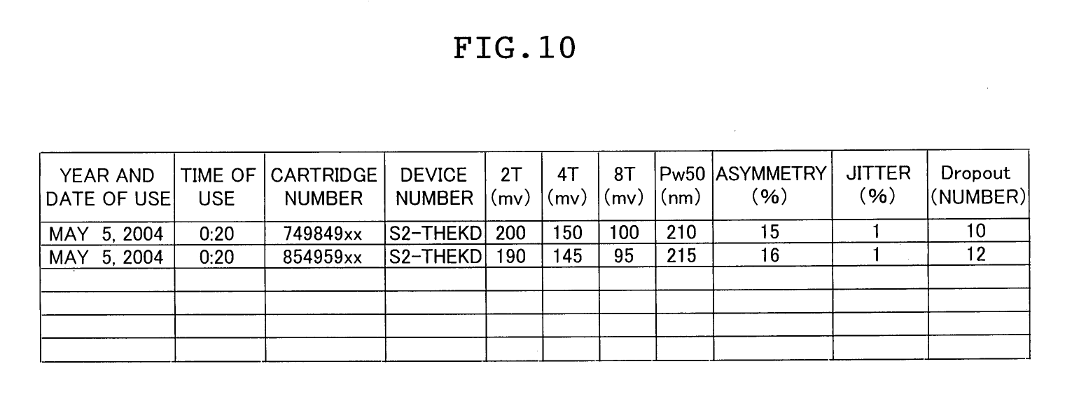

When the device number of the magnetic tape recording and reproducing apparatus 2, the cartridge number of the magnetic tape, the error rate, the number of dropouts and the like are used as the history information, the history information may be obtained from the magnetic tape recording and reproducing apparatus 2 by controlling the control PC 6. Then, the date and time of use, the measured values of the factor estimation signal output from the data collecting device, the device number, the magnetic tape cartridge number, the error rate, the number of dropouts and the like are output to the magnetic tape recording and reproducing apparatus 2 as the history information to record the history information in a predetermined area of the magnetic tape. An example of the history information as described above is shown in FIG. 10. The history information shown in FIG. 10 is composed of the date of use, the time of use, the cartridge number, the device number, the peak level of the 2T signal corresponding to the error factor estimation data, the peak level of the 4T signal, the peak level of the 8T signal, the Pw50, the asymmetry, the jitter and the number of dropouts. The history information can be displayed on, for example, the monitor 62 connected to the control PC 6.

The history information is recorded on the magnetic tape for each use. As a result, a change or a trend of the factor estimation signal for each used magnetic tape or each apparatus for recording and reproducing the magnetic tape can be checked. Therefore, the factor of occurrence of the error can be further easily estimated.

Surrounding information such as a temperature in or out of the apparatus or a humidity can also be used as the history information. The surrounding information and the factor estimation signal obtained by reading the factor estimation signal are compared with each other for examination to check the correlation between them. As a result, the factor of the error can be more easily estimated.

In this embodiment, the example where the history information is recorded in the predetermined area (the history information recording area) of the magnetic tape has been described. Alternatively, an RF-ID (Radio Frequency Identification) may be provided for the cartridge housing the magnetic tape to record the history information in the RF-ID. In this case, an RF-ID recording and reproducing apparatus for recording the history information in the RF-ID and reading out the recorded history information is provided for the magnetic tape recording and reproducing apparatus. Furthermore, a memory for recording the history information in the magnetic tape recording and reproducing apparatus or the control PC can also be provided in a separate manner so that the history information is recorded in the memory. By recording the history information in the RF-ID or the memory for each use so that the history information recorded for each use is checked as described above, for example, the cartridge having the factor of occurrence of the error can be specified or the correspondence with the surrounding information can be obtained.

Since the factor of increase in the error rate can be estimated in the above-described error factor estimating system according to the present invention, the operation for removing the factor can be quickly and appropriately performed. Moreover, if the data for specifying the factor of the error in the recording medium is used as the factor estimation signal, the recording medium can be easily evaluated. Thus, the inspection apparatus of the error factor estimating system described above can be used as an evaluation device of the recording medium.

Moreover, according to the error factor estimating system of the present invention, since a change in the error rate can be predicted before the error rate actually changes, the occurrence of an error can be avoided. Furthermore, an error can be estimated based on the factor estimation signal obtained by reproducing the error factor estimation data, the factor of the error can be estimated without deleting and affecting the use’s data. Furthermore, by recording the history information in the control PC connected to the recording and reproducing apparatus or the recording and reproducing apparatus itself each time the recording and reproducing apparatus is used, the history can be checked to specify the cartridge having the factor of the error or to obtain the correspondence with the surrounding information (the environment temperature or the humidity).

The error factor estimating method, the error factor estimating system, the digital recording and reproducing apparatus and the recording medium according to the present invention have been described above in detail. However, the present invention is not limited to the above-described embodiments. It is apparent that various modifications and changes are possible without departing from the scope of the present invention.

What is claimed is:

1. An error factor estimating method for estimating a factor of an error occurring when information recorded on a digital recording medium is reproduced by a digital recording and reproducing apparatus, said error factor estimating method comprising the steps of:
recording error factor estimation data on said digital recording medium;
reproducing said error factor estimation data from said digital recording medium to obtain an error factor estimation signal; and
estimating said factor of the error based on said error factor estimation signal.

2. The error factor estimating method according to claim 1, wherein said error factor estimation data contains a data string providing a solitary inverted waveform during reproduction.

3. The error factor estimating method according to claim 1, wherein said error factor estimation data contains a data string repeated in a cycle selected from the group consisting of 2T, 4T and 8T where T is a recording channel clock cycle.

4. The error factor estimating method according to claim 1, further comprising steps of:
measuring an error rate from said medium and
comparing the error rate with said error factor estimation signal.

5. The error factor estimating method according to claim 1, further comprising the steps of comparing the factor estimation signal with a preset threshold value to display a position of occurrence of the error based on the result of comparison on a display device.

6. The error factor estimating method according to claim 1, further comprising the steps of:
comparing said error factor estimation signal with a preset threshold value; and
determining whether or not said information is recorded based on the result of comparison in said step of comparing.

7. The error factor estimating method according to claim 1, wherein said preset threshold value is preset for at least one selected from the group consisting of a maximum amplitude value of said error factor estimation signal, a full width at half-maximum corresponding to a half amplitude of said maximum amplitude value, a jitter of said error factor estimation signal and asymmetry of said error factor estimation signal.

8. The error factor estimating method according to claim 1, further comprising recording said error factor estimation signal as a history for each use.

9. An error factor estimating system for estimating a factor of an error, comprising:
a recording medium recorded error factor estimation data for estimating a factor of a error thereon;
a recording and reproducing device for recording information on said recording medium and reproducing said information therefrom; and
an inspection device for inspecting a state of at least one of said recording medium and said recording and reproducing device connected there to said inspection device based on an error factor estimation signal obtained by reproducing said error factor estimation data with said recording and reproducing device.

10. The error factor estimating system according to claim 9, wherein said inspection device includes:
a measuring section for measuring at least one of a maximum amplitude value of said error factor estimation signal, a full width at half-maximum corresponding to a half amplitude of the maximum amplitude value, a jitter of said error factor estimation signal and asymmetry of said error factor estimation signal;
a collecting section for collecting measurement values measured by said measuring section; and
a first storage portion for storing said measurement value.

11. The error factor estimating system according to claim 10, wherein said inspection device includes a display section connected to said collecting section to display said measurement value.

12. The error factor estimating system according to claim 11, wherein said collecting section measures an error rate and compares said error rate with said measurement value stored in said first storage section and said display section displays a result of comparison.

13. The error factor estimating system according to claim 11, wherein said inspection device further includes:
a second storage section in which a threshold value for said measured value of said error factor estimation signal is preset;
said collecting section compares said error factor estimation signal and said threshold value with each other to estimate a position of occurrence of the error based on the result of comparison; and
said display section displays said estimated position of occurrence of the error.

14. The error factor estimating system according to claim 9, wherein said inspection device controls the recording or the reproduction of said recording and reproducing device based on the result of comparison.

15. The error factor estimating system according to claim 9, wherein
said recording medium is housed within a cartridge having a recording section for recording said error factor estimation signal detected for each use as history information; and
said recording and reproducing device includes a history information recording and reproducing section for recording history information in said recording section of said cartridge and reproducing said recorded history information.

16. A digital recording and reproducing apparatus comprising:
a recording and reproducing section for recording information on a recording medium and reproducing the recorded information therefrom, said recording medium recorded error factor estimation data for estimating a factor of an error thereon;
a recording and reproduction control section for controlling a recording and reproducing operation of said recording and reproducing section;
a memory for storing a threshold value for a error factor estimation signal obtained by reproducing said error factor estimation data in said recording and reproducing section; and
an arithmetic processing unit for comparing said error factor estimation signal with said threshold value to generate a control signal for controlling said recording and reproducing operation of said recording and reproducing section based on the result of comparison to output said control signal to said recording and reproduction control section.

17. The digital recording and reproducing apparatus according to claim 16, wherein said control signal is for controlling start and stop of the recording of the information on said recording medium.

18. The digital recording and reproducing apparatus according to claim 16, said recording and reproducing section records said error factor estimation signal on said recording medium as said history information for each use.

19. The digital recording and reproducing apparatus according to claim 16, wherein
said recording medium is housed within a cartridge having a recording section for recording said history information; and
said recording section includes a history information recording section for recording said history information on said recording section.

20. The digital recording and reproducing apparatus according to claim 16, wherein said storage section is an RFID.

21. A recording medium for recording information thereon and reproducing the information therefrom by using a digital recording and reproducing device, the recording medium comprising:
error factor estimation data for estimating a factor of an error occurring when the information is recorded and reproduced by using said digital recording and reproducing device.

22. The recording medium according to claim 21, wherein said error factor estimation data contains a data string providing a solitary inverted waveform during reproduction.

23. The recording medium according to claim 21, wherein said error factor estimation data contains a data string repeated in a cycle selected from the group composing of 2T, 4T and 8T where T is a recording channel clock cycle.
